(19) United States
(12) Patent Application Publication
(10) Pub. No.: US 2006/0273227 A1
(43) Pub. Date: Dec. 7, 2006

(54) Auxiliary panpilot steady cam tripod

(76) Inventor: Eric Eugene Smith, Santa Barbara, CA (US)

Correspondence Address: Eric E. Smith, 315 Palisades Dr., Santa Barbara, CA, 93109, US

(21) Appl. No.: 11/378,782

(22) Filed: Mar. 20, 2006

Related U.S. Application Data
(60) Provisional application No. 60/635,156, filed on Jun. 6, 2005.

(51) Int. Cl. A47F 5/00; A47F 7/00; F16M 11/00; F16M 13/00

(52) U.S. Cl. 248/123.11

(57) ABSTRACT

What I would like to point out is that the Auxiliary Panpilot Steady Cam Tripod is the most complete steady cam tripod on the market today for video and still cameras that weight up to 8 pounds because of the 360 degree weight distribution from the three stackable wings that are adjusted by a bottom hand screw to lock any angle and counter balance any video camera up to 8 pounds.

### STATEMENT REGARDING FEDERALLY SPONSORED RESEARCH OF DEVELOPMENT

“Not applicable”

### REFERENCE TO SEQUENCE LISTING, A TABLE, OR A COMPUTER PROGRAM LISTING COMPACT DISC APPENDIX

“Not applicable”

### BACKGROUND OF THE INVENTION

The field of invention pertains to video and still cameras up to 8 pounds. References of the Auxiliary Panpilot have been featured in 3 magazines including: HDTV magazine December/January 2006, Camcorder and Computer Video magazine December 2005, and Videomaker May 2005, Also, Auxiliary Panpilot has been featured at DV.com and Wired.com website in December 2005. Auxiliary Panpilot received an Editors Choice Award at: www.dingbatmag.com website in December 2005. Dingbat magazine is a monthly magazine for “Cool Tools” for the video industry. The official web site for the Auxiliary Panpilot Steady Cam Tripod is www.panpilot.com 001

Specific problems in the past for steady cams are that they are fixed and not able to adjust the weight in any 360 degree direction like the Auxiliary Panpilot does. The steady cams on the market today are not able to be adjusted to counter balance the camera correctly which produces a rocky boat feel because the weights are up front and in back and not able to be moved which in turn gives you a swaying feel from side to side like a boat does in the water. The Auxiliary Panpilot is able to be counter balanced in any 360 degree fashion producing the best most attainable smooth feel for video/still cameras on the market today. 002

### BRIEF DESCRIPTION OF THE SEVERAL VIEWS OF THE DRAWING

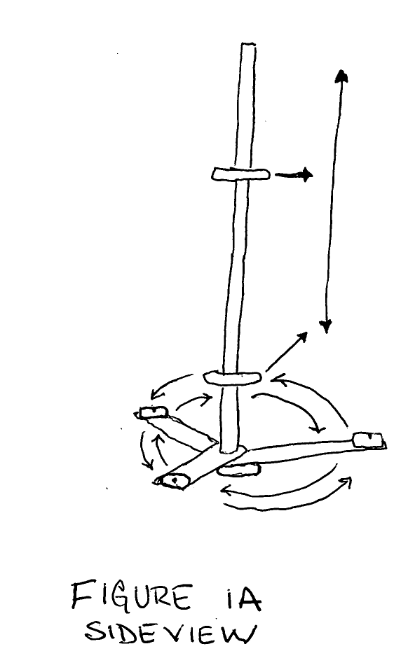

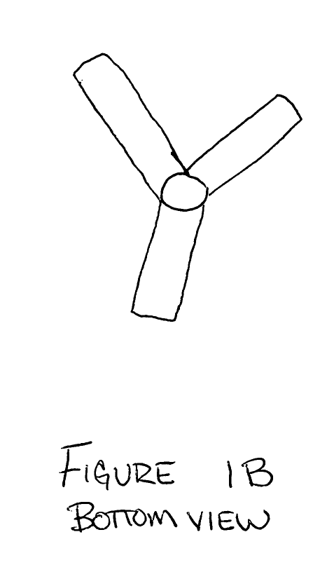

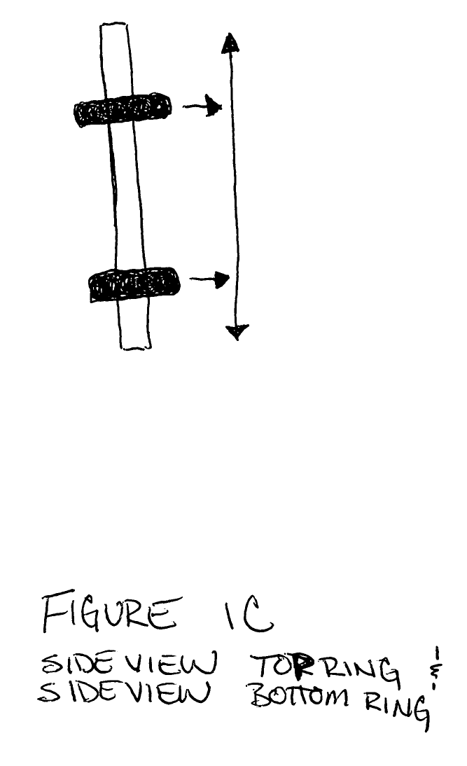

Drawing FIG. 1A is the side view of the Auxiliary Panpilot Steady Cam Tripod. The bending arrows show the three wings at the bottom able to be adjusted in any 360 degree angle. Steel weights are placed on the end of each wing to counter balance any video or still camera weighing up to 8 pounds. Two arrows from the two rings on the shaft is able to be adjusted up or down. The Top ring is for the adjustment of the camera and the bottom ring is for the stabilizer arms that tighten each wing for the tripod mode. 001

Drawing FIG. 1B is the bottom view of the Auxiliary Panpilot Steady Cam. The circle in the middle of the wings is the bottom hand screw that tightens or loosens to adjust the the three weighted wings. 002

Drawing FIG. 1C is the shaft with the top ring and bottom ring that can be adjusted up or down. The Top ring is for the adjustment of the camera to counter balance and the bottom ring is for the stabilizer arms to tighten each wing for the tripod mode. 003

### DETAILED DESCRIPTION OF THE INVENTION

What distinguishes the Auxiliary Panpilot from other inventions is that the other steady cams on the market today are fixed and not able to be adjusted in any 360 degree angle like the Auxiliary Panpilot improvement. If I may include the other steady cams on the market today to list what is old. The Glidecam is a fixed steady cam. On the bottom of the Glidecam has a weighted front leg and a weighted back leg with no adjustment of legs which produces a swaying boat like feel? The Steady Tracker is another steady cam with no 360 degree counter balanced weighting. The Steady Tracker's weighted legs are fixed and not able to be adjusted in a 360 degree angle. 001

The improvement is listed in paragraph above. The process of the Auxiliary Panpilot is by phone orders or online orders and then order is placed to Safar in Ohio and Master Craft Engineering in Ventura, Calif. Machined in Akron, Ohio at Safar Machine and in Ventura, Calif. at Master Craft Engineering. The machines are computer lathes and drill presses. The composition of matter is aluminum for the shaft and three wings. Three steel weights are attached to each at the end of each of the three wings. Also, stainless nuts and bolts are used on the wings that hold the stabilizer arms turn buckles. One turn buckle is attached on each of the three wings that is connected to the bottom shaft ring. 002

1. “What I claim as my invention is the three adjustable weighted wings that move in a complete 360 degree circle in either direction. The Adjustment of the three weighted wings at the bottom are able to be adjusted in any 360 degree fashion to counter balance any still or video camera weighting up to 8 pounds. Once the adjustment is made for counter balancing you are able to hand tighten the bottom hand screw to secure the unit.”
